(19) United States
(12) Patent Application Publication
(10) Pub. No.: US 2006/0239292 A1
(43) Pub. Date: Oct. 26, 2006

(54) DYNAMICALLY CONTROLLING ACCESS METHODS IN A WIRELESS NETWORK

(75) Inventors: Emanuel Kahana, Chicago, IL (US); Aparna Pandey, Chicago, IL (US); Ron Rotstein, Austin, TX (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/380,046

(22) Filed: Apr. 25, 2006

Related U.S. Application Data
(60) Provisional application No. 60/674,740, filed on Apr. 26, 2005.

(51) Int. Cl. H04Q 7/24; H04Q 7/00; H04J 3/22; H04J 3/16

(52) U.S. Cl. 370/437; 370/465; 370/328; 370/338

(57) ABSTRACT

A system (100) that includes a device (120), such as an access point, which is configured for: obtaining (210) a status of a busy channel indicator; and dynamically selecting (220) an access scheme within a contention free period interval based on the status of the busy channel indicator.

### FIELD OF THE INVENTION

The present invention relates generally to wireless networks and more specifically to a method and apparatus for dynamically controlling co-existence of access methods.

### BACKGROUND OF THE INVENTION

The Institute of Electrical and Electronics Engineers (IEEE) 802.11 standard for wireless local area networks (WLANs) specifies two methods of access to a network (medium), namely, a contention-based method such as a Distributed Coordination Function (DCF) and a polling-based method such as a Point Coordination Function (PCF). In the case of DCF, a station (STA) forming part of a WLAN needs to sense the medium to determine if any other STA is transmitting on the medium. In such an event, when the medium is being used, in order to avoid contention, the STA defers its transmission until the medium is available and free to transmit. When the medium is available, the STA starts transmission after performing the appropriate checks. In the case of PCF, a point co-ordinator (PC) operates at an access point (AP) of a network basic service set (BSS). The PC acts as a polling master and based on a predetermined methodology performs polling of a plurality of stations connected to the network, and allows each STA access to the medium for transmission. Therefore, the PC controls access to the network and the transmissions thereof.

A comparative analysis of PCF and DCF is helpful in demonstrating some shortcomings of both access schemes. DCF is most efficient for low traffic, but as traffic on the network increases, DCF data rate performance falls sharply due to long contention periods and collisions. Moreover, instances of denial of service occur more often. In comparison, PCF is less effective at low traffic due to overhead, but it performs better in high traffic conditions and its performance degrades more gracefully. Also, in outdoor deployments in urban area, often stations may be blocked by buildings and unable to hear other stations, thereby causing collisions to occur more often. Another issue is the potential of an attack by a hacker, who may modify his station to effectively prioritize service to himself at the expense of other users. A rogue device could also disrupt DCF service by constantly transmitting a low power signal. This signal can cause resource starvation, i.e., a denial-of-service attack, to other stations in the network.

Thus, there exists a need for dynamically synchronizing the access methods with the traffic load existing on the network media in order to take advantage of the benefits of a dual access scheme while minimizing the above shortcomings.

### BRIEF DESCRIPTION OF THE FIGURES

A preferred embodiment of the invention is now described, by way of example only, with reference to the accompanying figures in which:

FIG. 1 illustrates a block diagram of a wireless communication system in accordance with embodiments of the present invention;

FIG. 2 illustrates a flow diagram of a method for dynamically controlling an access scheme in a wireless communications network in accordance with embodiments of the present invention;

FIG. 3 illustrates a flow diagram of a method of controlling an access scheme, at an access point, in a wireless communication network in accordance with embodiments of the present invention;

FIG. 4 illustrates a contention free interval that is configurable in accordance with embodiments of the present invention; and

FIG. 5 illustrates a flow diagram of a method of transmission using an access scheme, at a station, in a wireless communications network in accordance with embodiments of the present invention.

### DETAILED DESCRIPTION OF THE INVENTION

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, common and well-understood elements that are useful or necessary in a commercially feasible embodiment may not be depicted in order to facilitate a less obstructed view of these various embodiments. Also, elements shown in the figures have not necessarily been drawn to scale. For example, the dimensions of some of the elements are exaggerated relative to each other. Further, where considered appropriate, reference numerals have been repeated among the figures to indicate corresponding elements.

Generally speaking, pursuant to the various embodiments, the present invention facilitates the improvement of Quality of Service (QoS) in a wireless local area network (WLAN) by dynamically controlling the co-existence of a number of alternative access schemes or methods, namely, a contention-based access method, a polling-based access method and a schedule-based access method. The invention offers the advantage of efficient bandwidth utilization based on a data traffic being communicated on a channel, i.e., a channel loading. Channel loading is ideally measured using a busy channel indicator, for instance a Clear Channel Indicator (CCA) as in the IEEE 802.11 standard. Those skilled in the art will appreciate that the above recognized advantages and other advantages described herein are merely exemplary and are not meant to be a complete rendering of all of the advantages of the various embodiments of the present invention.

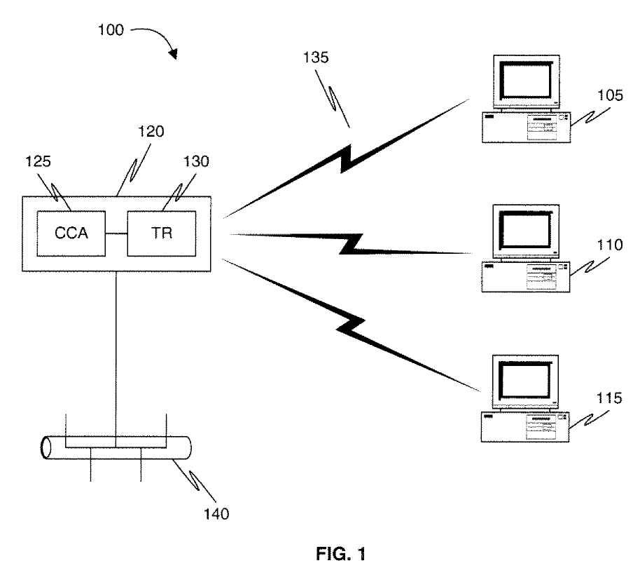

Referring now to the drawings, and in particular FIG. 1, a block diagram of a wireless communication system or network in accordance with embodiments of the present invention is shown and indicated generally at 100. Those skilled in the art, however, will recognize and appreciate that the specifics of this illustrative example are not specifics of the invention itself and that the teachings set forth herein are applicable in a variety of alternative settings. For example, although the specific embodiments are described by reference to wireless networks that operate in accordance with the IEEE 802.11 standard, the teachings described do not depend on a particular wireless network but can be applied to any type of wireless network that includes a device such as an access point that works in co-ordination with a busy channel indicator as shown in this embodiment. As such, other alternative implementations of using different types of wireless network topologies are contemplated and are within the scope of the various teachings described. Moreover, it should be further appreciated that reference herein to “the IEEE 802.11 standard” includes all related standards and standard drafts in the 802.11 family that may utilize the teachings of the present invention such as, for instance, the 802.11a standard, the 802.11 μg standard, etc.

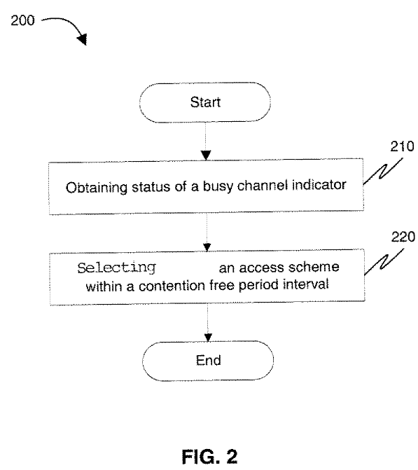

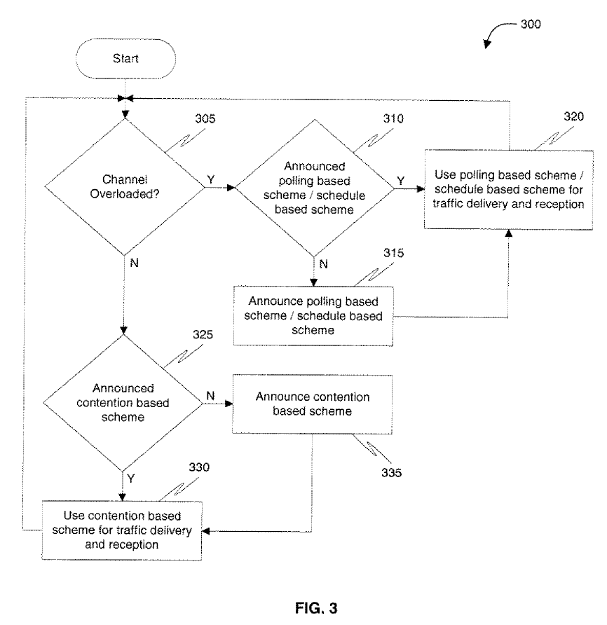

Returning to FIG. 1, a network 100 comprises stations 105, 110 and 115, an access point 120 and a network backbone or infrastructure 140. The stations 105, 110 and 115 may comprise, for example, a personal computer (PC), a laptop, a mobile device, etc., and are each illustrated in FIG. 1 as a PC. The access point functions as a connection between the stations 105, 110, 115 and the network backbone 140 for network access. The stations 105, 110, 115 may be connected to the access point 120 by a wireless connectivity provided, for instance, by an adapter card, a PC Card, or an embedded device installed on the stations 105, 110, 115. The wireless connectivity between stations 105, 110, 115 and the access point 120 is through a wireless channel 135. The access point 120 may be connected to the network backbone 140 either directly as a conventional wireless connection or wired connection (as shown in FIG. 1) or through one or more wired or wireless hops. Those skilled in the art would appreciate that the backbone network could comprise one of a wired network or a wireless network. In an embodiment of the present invention, the access point 120 comprises a module 130 that further comprises a transceiver and a processor operatively coupled to the transceiver in a manner well known in the art and configured to implement methods in accordance with various embodiments of the present invention, for example, as described below by reference to FIGS. 2 and 3. Further, the access point 120 may comprise a busy channel indicator operatively coupled to the transceiver and processor in a manner well known in the art such as, for instance, a Clear Channel Assessment (CCA) indicator 125 to indicate the status of the wireless part of network 100, as mentioned in the IEEE 802.11 standard.

Network 100 is illustrated with a single access point and three stations for clarity of illustration. However, those skilled in the art will realize that typically a network would contain many more stations and access points. Moreover, those skilled in the art will further realize that although functionality in accordance with various methods of the present invention is illustrated as residing in an access point, in other embodiments this functionality may alternately reside in other devices in the network that may or may not be co-located with the access point, for example a centrally located switch, an authentication, authorization and accounting (AAA) server, or a server that manages the network. Further, in an embodiment as mentioned above, wherein the backbone network is wireless, a station forming part of the network could act as an access point.

Turning now to FIG. 2, a flow diagram of a method for dynamically controlling an access scheme in a wireless communications network in accordance with embodiments of the present invention is shown and generally indicated at 200. The method is ideally performed by an access point, for example, as described above by reference to FIG. 2. The access point obtains (210) the status of a busy channel indicator, and dynamically selects (220) an access scheme within a contention free period interval based on the status of the busy channel indicator. The busy channel indicator is a measure of the traffic or channel loading on the network backbone 140. In an embodiment of the invention, the busy channel indicator is a Clear Channel Assessment indicator (CCA) 125 as in the IEEE 802.11 standard.

In another embodiment of the invention, the channel loading is defined by one or more indicators that are tracked as a measure of the network traffic, for instance, an indicator of whether a channel loading is above or below a predetermined value and/or an indicator of whether the channel loading has been above or below the predetermined value for a predetermined time interval. Based on the measure of the indicators, the access point 120 may control the access scheme by switching between a contention-based scheme, a polling based scheme and a schedule based scheme in order to optimize the use of the network. In one embodiment of the invention, the contention-based scheme is a Distributed Co-ordination Function (DCF) and the polling-based scheme is a Point Co-ordination Function (PCF). The module 130 can control the access scheme by communicating the access scheme to the stations 105, 110, 115. Such dynamic switching has the advantage of being able to synchronize the access method with the data traffic on the network. For the stations 105, 110, 115 to switch to a polling based scheme, the access point 120 shall be configured to support a polling based scheme and the stations 105, 110, 115 shall be configured to support the polling based scheme. Whether the access point 120 and the stations 105, 110, 115 support the polling based scheme may be established during a conventional association phase or a re-association phase of the stations 105, 110, 115 with the access point 120, as is well known in the art.

Thus, pursuant to embodiments of the present invention, the access point 120 is typically responsible for tracking the channel loading and dynamically selecting the access scheme based on the channel loading. Additionally, the access point 120 ideally announces the access scheme to a plurality of stations 105, 110, 115 that are connected to the wireless communication system. Turning now to FIG. 3, a flow diagram of a method in accordance with embodiments of the present invention for controlling the access scheme within a contention free interval in the wireless communication network at the access point is shown and generally depicted at 300. As depicted in step 305, the access point 120 obtains the status of a busy channel indicator 125 for a predetermined time interval. The busy channel indicator 125 is an indication of a channel overloading, and the parameters that are monitored include, namely, whether the channel loading is above or below a predetermined value and/or whether the channel loading has been above or below the predetermined value for a predetermined time interval. The predetermined value and the predetermined time interval can be set as per data traffic requirements identified and acceptable for the communications network. In an embodiment of the invention, the busy channel indicator 125 is a clear channel assessment indicator, which is continuously monitored by the access point 120. The access point 120 can determine whether the channel loading was above the predetermined time interval by calculating the total time for which the channel had been loaded. In another embodiment, a station can also monitor the channel loading based on its busy channel indicator and related parameters. It can report the measured channel loading to the access point 120, for instance, in a channel-loading report message that includes the channel loading information and optionally, the length of time over which the channel loading was observed to be the reported value or above the threshold value. The access point 120, at receiving such a message, can determine whether the channel is overloaded or not.

In case the channel loading is calculated to be above the predetermined value, for example, for a predetermined time interval such as, for instance, a time interval determined by the access point, the access point 120 can select a polling based scheme either by instantaneously changing the access scheme, (i.e., transmitting a message to all the stations immediately indicating a change in access scheme); waiting until a next beacon to change the access scheme and announce it; or keeping the access scheme the same where the polling based scheme is already in use, to increase the efficiency of the channel for high channel loading. Therefore, as depicted in step 310, the access point 120 can identify and confirm whether the access scheme being used is a polling based scheme (such as PCF). In the case where the polling based scheme is already in use, this scheme continues to be used as depicted in 320. However, in the case where the access scheme would need to change, the access point communicates a message to all stations within the network to change their scheme to the polling based scheme, as depicted in step 315. If the channel loading is not above the predetermined value or if the channel loading has been above the predetermined value for a time interval less than the predetermined time interval specified previously, the access point 120 first confirms whether a contention based scheme (such as DCF) was being used in the network, as depicted in step 325, since the contention based scheme is an efficient access scheme at a low channel loading. When the stations 105, 110, 115 are already using the contention based scheme, as depicted in step 330, the access point 120 continues with the contention based scheme. As stated previously, in the event of a need to change the access scheme being used, the access point 120 communicates a message, to all the stations 105, 110, 115 to change the current scheme being used to the contention based scheme, as depicted in step 335.

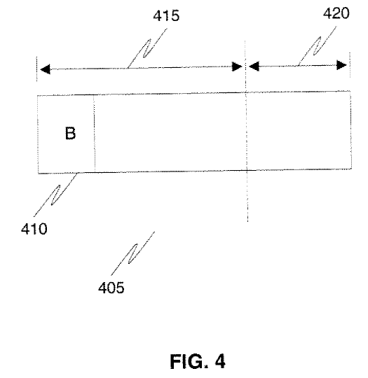

The method 300 of determining the channel loading and subsequently selecting the access scheme is ideally repeated in each of a plurality of contention free intervals. Turning now to FIG. 4, an exemplary contention free interval in accordance with embodiments of the present invention is shown and generally indicated at 405. In an embodiment of the invention, a contention free interval 405 is a programmable number of beacon intervals 410. A beacon is a wireless LAN packet that is typically transmitted by the access point to signal relevant information about the wireless network, for example, the information regarding timing synchronization, beacon interval, pending traffic for stations, the data rates used by the AP etc. The embodiment depicts that the interval 415 and 420 can be varied dynamically and the intervals 415 and 420 can depict a time interval corresponding to an access scheme comprising a contention based scheme, a polling based scheme or a schedule based scheme.

In an embodiment of the invention, where a schedule based scheme is implemented, an access scheme announcement may further include sending a schedule message after a beacon when the access scheme is changed to a schedule based access scheme. For example, in one embodiment using 802.11e extensions, a Hybrid Control Channel Access (HCCA) scheme may be used to communicate the schedule message after the beacon 410. In another embodiment one schedule message is sent per station, using the given station's address as the destination address of the frame. In yet another embodiment, one schedule message is sent to a group of stations using a group address as the destination address of the frame. The schedule based access method typically includes, transmitting the schedule message that conveys how often, how long and when the stations will be provided with access to the channel. This permits a station to wake up only when it is scheduled and then transmit and receive more than one MAC protocol data unit (MPDU) during the time the station is granted access to the medium. The embodiment therefore provides an advantage that the stations can take advantage of power saving and transmit more than one MPDU. The schedule frame(s) is (are) typically transmitted after a beacon.

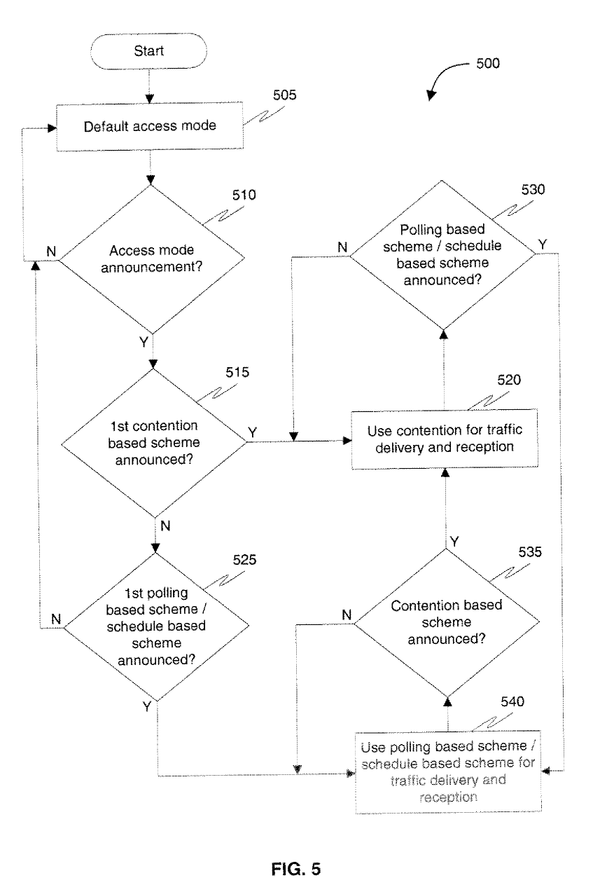

In accordance with the present teachings, the access point 120 is typically responsible for tracking the channel loading, selecting the access scheme and announcing the same to all the stations 105, 110, 115 that are connected to the network. On the other hand, the station 105, 110, 115 would need to discover the access scheme to be used and based on such determination, change the access scheme being used to either a contention based scheme, a polling based scheme or a schedule based scheme based on the calculations performed by the access point 120. In FIG. 5, a flow diagram of a method in accordance with embodiments of the present invention implemented at the stations 105, 110, 115 for using an access scheme during transmission based on a desired access scheme announced by the access point 120, is shown and generally indicated at 500. A default mode is made permissible when the access point fails or does not provide any announcement of the desired access scheme, as depicted in step 505. In the event that an announcement of the desired access scheme is received by the station 105, 110 115, as shown in 510, it checks whether the desired access scheme is a contention based scheme (such as DCF), as in step 515, and then uses the contention based scheme for traffic delivery and reception as depicted in step 520. However, if the desired access scheme received by the station 105, 110, 115 is a polling based scheme (such as PCF) or a schedule based access scheme, as in step 525, the station switches the access scheme being used, if needed, and uses the polling based scheme or the schedule based access scheme for traffic delivery and reception as in 540. The station 105, 110, 115 would also need to change the current access scheme being used if the announcement received from the access point 120 indicates the desired mode as being different from the current access scheme. For example, if the announcement received indicates the use of the polling based scheme when the station 105, 110, 115 is operating in a contention based scheme, as depicted in step 530, the station will change it's the access scheme it uses to a polling based scheme as in step 540. Similarly, when the station 105, 110, 115 receives the desired mode as a contention based scheme when it is operating in a polling based scheme, as depicted in step 535, it will change its access scheme to the contention based scheme as in step 520. Additionally, if the desired access scheme announcement comprises a schedule based scheme that conveys to the stations 105, 110, 115 how often and when they will have access to the channel, the stations can remain dormant for the time being and wake up only when they are scheduled to transmit and receive the data and the data can then be transferred or received more than an MPDU at a stretch. As stated previously, this provides an additional advantage of power saving at the station.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A method of controlling an access scheme within a contention free interval in a wireless communications network, the method comprising the steps of:
obtaining a status of a busy channel indicator; and
selecting the access scheme within the contention free period interval based on the status of the busy channel indicator.

2. The method of claim 1, wherein the access scheme is selected based on the busy channel indicator having the same status for a predetermined time interval.

3. The method of claim 1, wherein the access scheme is one of a contention-based method, a polling-based method and a schedule-based method.

4. The method of claim 3, wherein the contention-based method is a Distributed Coordination Function (DCF) and the polling-based method is a Point Coordination Function (PCF).

5. The method of claim 1 further comprising the step of communicating the selected access scheme on the wireless communications network.

6. The method of claim 5, wherein the selected access scheme is communicated in a beacon.

7. The method of claim 6, wherein a Hybrid Control Channel Access scheme is used to communicate a schedule message after the beacon when the access scheme selected is a schedule-based method.

8. The method of claim 1, wherein the busy channel indicator is a Clear Channel Assessment (CCA) indicator.

9. The method of claim 1, wherein the status of the busy channel indicator is determined in an access point.

10. The method of claim 1, wherein the status of the busy channel indicator is determined in a station and received in an access point from the station.

11. A device comprising:
a transceiver; and
a processor operatively coupled to the transceiver and configured for performing the steps of:
obtaining a status of a busy channel indicator; and
selecting an access scheme within a contention free period interval based on the status of the busy channel indicator.

12. The device of claim 11, wherein the device is an access point.

13. The device of claim 11 further comprising a busy channel indicator operatively coupled to the transceiver and the processor and that is a Clear Channel Assessment indicator.

14. The device of claim 11, wherein the communication device is included in a system that is operated in accordance with an Institute of Electrical and Electronics Engineers 802.11 standard.

15. A system that includes a device comprising:
a transceiver; and
a processor operatively coupled to the transceiver and configured for performing the steps of:
obtaining a status of a busy channel indicator; and
selecting access scheme within a contention free period interval based on the status of the busy channel indicator.

16. The system of claim 15, wherein the system is operated in accordance with an Institute of Electrical and Electronics Engineers 802.11 standard.

17. The system of claim 15, wherein the device is an access point.

18. The system of claim 15, wherein the device further comprises a busy channel indicator operatively coupled to the transceiver and the processor and that is a Clear Channel Assessment indicator.
